(19) United States
(12) Patent Application Publication
(10) Pub. No.: US 2024/0095744 A1
(43) Pub. Date: Mar. 21, 2024

(54) DATA ELEMENT ANALYSIS FOR FRAUD MITIGATION

(71) Applicant: Wells Fargo Bank, N.A., San Francisco, CA (US)

(72) Inventors: Alan W. Hecht, Chanhassen, MN (US); Andrea Renee Leighton, San Francisco, CA (US)

(73) Assignee: Wells Fargo Bank, N.A., San Francisco, CA (US)

(21) Appl. No.: 18/370,677

(22) Filed: Sep. 20, 2023

Related U.S. Application Data
(60) Provisional application No. 63/408,706, filed on Sep. 21, 2022.

(51) Int. Cl. G06Q 20/40

(52) U.S. Cl. CPC G06Q 20/4016

(57) ABSTRACT

A method includes: receiving, by at least one processing circuit of a provider computing system associated with a provider institution, an action notification regarding an action associated with an account held by a customer at the provider institution; obtaining, by the at least one processing circuit, user action information associated with the action; performing, by the at least one processing circuit, a fraud detection analysis based on the user action information, the fraud detection analysis comprising generating a plurality of individual risk values associated with a plurality of fraud data risk elements based on the user action information; determining, by the at least one processing circuit, that the action is fraudulent based on the plurality of individual risk values associated with the plurality of fraud data risk elements; and performing, by the at least one processing circuit, a fraud mitigation action based on determining that the action is fraudulent.

### CROSS-REFERENCE TO RELATED PATENT APPLICATION

This application claims the benefit of and priority to U.S. Provisional Patent Application No. 63/408,706, titled “DATA ELEMENT ANALYSIS FOR FRAUD MITIGATION,” filed Sep. 21, 2022, which is incorporated herein by reference in its entirety and for all purposes.

### TECHNICAL FIELD

The present disclosure relates to systems and methods for data element analysis and fraud mitigation.

### BACKGROUND

Fraudsters continue to become increasingly sophisticated in their techniques for perpetrating fraud on innocent customers. In some instances, customers who fall victim to fraud using certain payment channels are protected through various governmental regulations based on the fraud being “unauthorized” fraud. That is, in these scenarios, customers are able to recoup or otherwise recover their lost funds or other assets. However, some popular payment channels, by their nature, enable fraudsters to induce customers to authorize transfers to the fraudsters, and thus do not meet the classification of “unauthorized” fraud. As such, customers falling victim to this type of fraud or scam are not protected and have no way to recoup or otherwise recover their lost funds. This type of scam is known as “authorized fraud.” Given the volume of transactions that take place on a daily basis, these “authorized fraud” scams are a significant concern for the financial market at large.

### SUMMARY

One embodiment relates to a method. The method includes receiving, by at least one processing circuit of a provider computing system associated with a provider institution, an action notification regarding an action associated with an account held by a customer at the provider institution. The method further includes obtaining, by the at least one processing circuit, user action information associated with the action. The method further includes performing, by the at least one processing circuit, a fraud detection analysis based on the user action information, the fraud detection analysis including generating a plurality of individual risk values associated with a plurality of fraud data risk elements based on the user action information. The method further includes determining, by the at least one processing circuit, that the action is fraudulent based on the plurality of individual risk values associated with the plurality of fraud data risk elements. The method further includes performing, by the at least one processing circuit, a fraud mitigation action based on determining that the action is fraudulent.

Another embodiment relates to a provider computing system including one or more processing circuits including one or more processors and one or more memories having instructions stored thereon that, when executed by the one or more processors, cause the one or more processors to receive an action notification regarding a transfer request associated with an account held by a customer at a provider institution. The instructions further cause the one or more processors to obtain user action information associated with the transfer request. The instructions further cause the one or more processors to perform a fraud detection analysis based on the user action information, the fraud detection analysis including generating a plurality of individual risk values associated with a plurality of fraud data risk elements based on the user action information. The instructions further cause the one or more processors to determine that the transfer request is fraudulent based on the plurality of individual risk values associated with the plurality of fraud data risk elements. The instructions further cause the one or more processors to perform a fraud mitigation action based on determining that the transfer request is fraudulent.

Still another embodiment relates to a non-transitory computer-readable medium having instructions stored thereon that, when executed by at least one processing circuit of a provider computing system associated with a provider institution, cause operations including receiving an action notification regarding an action associated with an account held by a customer at the provider institution. The operations further include obtaining user action information associated with the action. The operations further include performing a fraud detection analysis based on the user action information, the fraud detection analysis including generating a plurality of individual risk values associated with a plurality of fraud data risk elements based on the user action information. The operations further include determining that the action is fraudulent based on the plurality of individual risk values associated with the plurality of fraud data risk elements. The operations further include performing a fraud mitigation action based on determining that the action is fraudulent.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

FIG. 1 is a block diagram of a computing environment for identifying potentially fraudulent activities associated with a provider, according to an example embodiment.

FIG. 2 is a flow diagram of a method for mitigating fraud using a data element analysis, according to an example embodiment.

FIG. 3 is a flow diagram of a method for a customer attempting a potentially fraudulent action, according to an example embodiment.

FIG. 4 depicts a graphical user interface including a fraudulent action alert, according to an example embodiment.

### DETAILED DESCRIPTION

Referring generally to the figures, systems and methods for mitigating fraud using a data element analysis are disclosed. In some instances, the systems and methods described herein allow for various data elements associated with customer account actions to be analyzed, weighted, and valued or scored according to their respective fraud risks. Various fraud detection rules are then be applied to the fraud risk values or scores to determine whether a given customer account action performed on a given customer account meets a predefined threshold indicative of the action being potentially fraudulent. Beneficially, the systems and methods described herein allow for a variety of data elements to be analyzed both individually and in conjunction with one another to better understand whether a given account is likely associated with fraudulent activity. Furthermore, the systems and methods described herein allow for the various fraud detection rules, weight, and values or scores to be automatically updated upon the introduction of additional confirmed fraudulent information, thereby ensuring or substantially ensuring efficient detection of continuously updated and modified fraud techniques used by sophisticated fraudsters.

As one example, in many instances, fraudsters send messages requesting urgent payments over transfer services (e.g., Zelle®, Billpay, wire transfer services). In many instances, the fraudsters register a transfer service token using an e-mail address that is intended to appear affiliated with a legitimate source (e.g., “WellsFargoDisputes@business.com” or “BillPay@consultant.com”). The fraudster will then use personal information about the innocent customer obtained through various channels (e.g., social data, dark web data) to craft their payment request in a way that further aids in convincing the innocent customer that they are a legitimate source.

Under various federal regulations, “unauthorized” fraud is protected, such that customers who are scammed or defrauded are able to recoup their lost funds. However, many transfer services (e.g., Zelle®, Billpay, wire transfer services) require user authorization for a given transaction on the front end (e.g., concurrently with the user being actively scammed). In these instances, this fraud does not meet the “unauthorized” fraud requirements, and thus is not protected by these federal regulations. Accordingly, in the technical field of transfer systems that require front-end authorization, a problem has been preventing “authorized” fraud before the associated transactions are authorized and/or minimizing the number of times a fraudster is able to commit “authorized” fraud before being discovered.

The systems and methods described herein beneficially address these problems by aiding in the prevention of “authorized” fraud before the associated transactions are authorized and/or during transactions in real- or nearly real-time by actively monitoring account openings and closings, transfer service registration processes, ongoing transactions associated with various customer accounts, and a variety of other user action information (e.g., information associated with a given transfer or transaction) to flag potentially fraudulent accounts and activity in real-time using a fraud detection analysis. The real or nearly real-time computerized fraud analysis process described herein utilizes various predefined and continuously or periodically updated processes that enable quick or relatively quick determination of potential fraud so to not noticeably impede or delay non-fraudulent transactions. In some embodiments, the use of machine learning (e.g., artificial intelligence) is utilized to further refine the fraud analysis processes described herein to adapt to changing tactics employed by fraudsters over time. That way, the systems and methods may evolve over time and continuously operate to effectively address the “authorized” fraud problem, as well as other types of fraudulent transfers.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

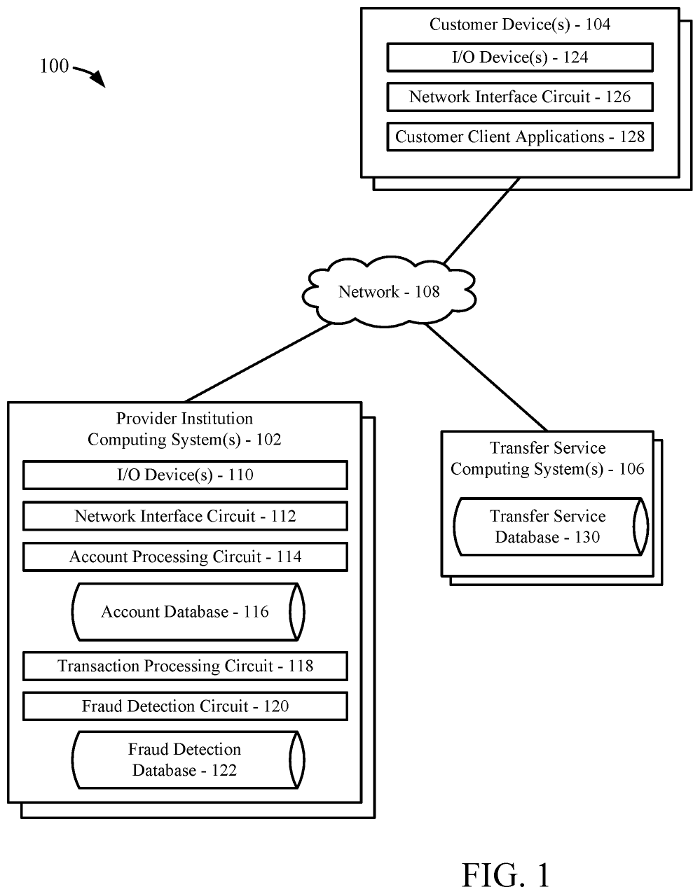

FIG. 1 is a diagram of a fraud mitigation computing environment or system 100 for identifying potentially fraudulent activities associated with a provider. As shown, the fraud mitigation computing environment 100 includes one or more provider institution computing systems 102, one or more customer devices 104, and one or more transfer service computing systems 106. The provider institution system(s) 102, the customer device(s) 104, and the transfer service computing system(s) 106 are in communication with each other and are connected by a network 108.

For clarity, the following description will refer to a provider institution computing system 102, a customer device 104, and a transfer service computing system 106. However, it will be understood that the following description of any of the provider institution computing system 102, the customer device 104, and/or the transfer service computing system 106 will be similarly applicable to any corresponding additional provider institution computing systems 102, customer devices 104, and/or transfer service computing systems 106, respectively, and that, in some embodiments, the computing environment 100 may include a plurality of any of the described devices and systems.

The provider institution computing system 102 is owned by, associated with, or otherwise operated by a provider institution (e.g., a bank or other financial institution) that maintains one or more accounts held by various customers (e.g., the customer associated with the customer device 104), such as demand deposit accounts, credit card accounts, receivables accounts, and so on. In some instances, the provider institution computing system 102, for example, may comprise one or more servers, each with one or more processing circuits having one or more processors configured to execute instructions stored in one or more memory devices to send and receive data stored in the one or more memory devices and perform other operations to implement the methods described herein associated with logic or processes shown in the figures. In some instances, the provider institution computing system 102 may comprise and/or have various other devices communicably coupled thereto, such as, for example, desktop or laptop computers (e.g., tablet computers), smartphones, wearable devices (e.g., smartwatches), and/or other suitable devices.

In some embodiments, the provider institution computing system 102 includes one or more I/O devices 110, a network interface circuit 112, an account processing circuit 114, an account database 116, a transaction processing circuit 118, a fraud detection circuit 120, and a fraud detection database 122. The one or more I/O devices 110 are configured to receive inputs from and display information to a user. While the term “I/O” is used, it should be understood that the I/O devices 110 may be input-only devices, output-only devices, and/or a combination of input and output devices.

In some instances, the network interface circuit 112 includes, for example, program logic that connects the provider institution computing system 102 to the network 108. The network interface circuit 112 facilitates secure communications between the provider institution computing system 102 and each of the customer device(s) 104 and the transfer service computing system(s) 106. The network interface circuit 112 also facilitates communication with other entities, such as other banks, settlement systems, and so on. The network interface circuit 112 further includes user interface program logic configured to generate and present web pages to users accessing the provider institution computing system 102 over the network 108.

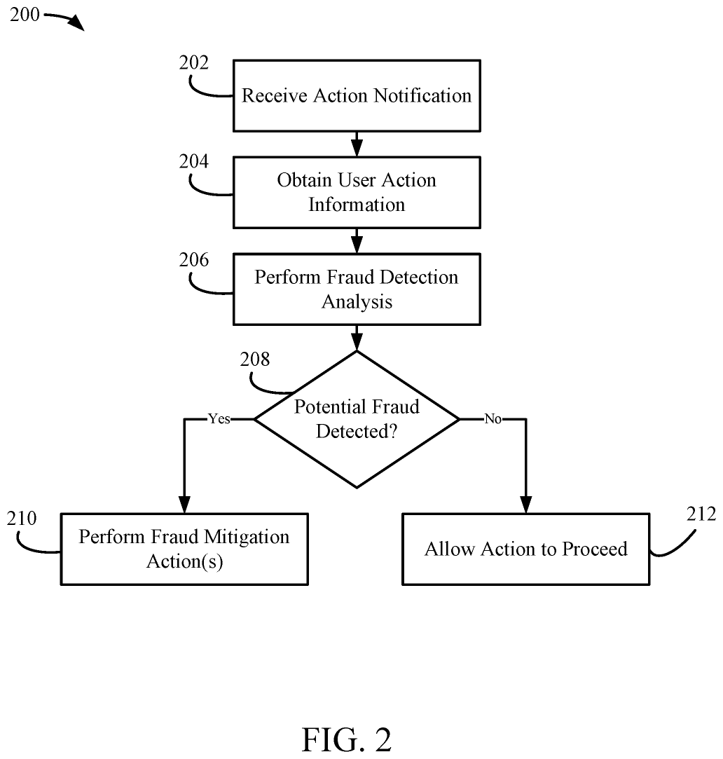

The account processing circuit 114 is structured or configured to perform a variety of functionalities or operations to enable and monitor various customer activities (e.g., account processing, product registration processing, account monitoring, etc.) in connection with customer account information stored within an account database 116. In some instances, the account processing circuit 114 performs various functionalities to enable account opening and/or closing actions, product registration and/or closing actions (e.g., registering for and/or closing a transaction service account associated with a transaction service provided by the transfer service computing system 106), account withdrawals and deposits (e.g., account credits and debits to checking and savings accounts), various customer account tracking activities, and/or a variety of other services associated with and/or provided by the provider. In some instances, the account processing circuit 114 is configured to, for each customer activity performed, automatically or nearly automatically pull customer account information (e.g., from the account database 116) pertaining to the customer and customer account associated with the customer activity and to transmit the customer account information to the fraud detection circuit 120 to be used in a fraud detection analysis, as will be described below, with reference to FIG. 2.

The account database 116 is structured or configured to retrievably store customer account information associated with various customer accounts held or otherwise maintained by the provider institution on behalf of its customers. In some instances, the customer account information includes both customer information and account information pertaining to a given customer account. For example, in some instances, the customer information may include a name, a phone number, an e-mail address, a physical address, etc. of the customer associated with the customer account. In some instances, the account information may include transaction information, information pertaining to the type and corresponding capabilities of the given account, a transfer service token (e.g., a phone number, an e-mail address, or a tag associated with a particular transfer service account) associated with the customer account, etc. of the customer account. As will be described further below, the account database 116 is configured to be used by the account processing circuit 114, the transaction processing circuit 118, and the fraud detection circuit 120 to identify various customer account information associated with various transfers and other activities (e.g., account openings and closings, product account registrations or closings) to enable the transfers and other activities while actively mitigating the risk of fraudulent activity.

The transaction processing circuit 118 is structured or configured to enable and monitor various customer transactions (e.g., the customer sending funds to a recipient, the customer receiving funds from a sender). In some instances, the transaction processing circuit 118 is further structured to incorporate at least some of the functionalities offered by the transfer service computing system 106 (e.g., via one or more APIs or SDKs of the transfer service computing system 106) to allow for customers to send and receive transfers of funds using transfer service tokens (e.g., via the customer client application 128 provided to the customer device 104 by the provider institution computing system 102). Accordingly, in some instances, the transaction processing circuit 118 is further structured to enable and monitor various transfer service fund transfers conducted by the customers.

In some instances, the transaction processing circuit 118 is structured to, for each transaction and/or transfer service fund transfer performed by each customer of the provider, automatically pull customer account information associated with the customer (e.g., from the account database 116), as well as sender/recipient account information associated with the sender or recipient (e.g., from the transfer service computing system 106), associated with a particular transaction or transfer service fund transfer. The transaction processing circuit 118 is then structured to transmit both the customer information and the sender/recipient information to the fraud detection circuit 120 to be used in a fraud detection analysis, as will be described below, with reference to FIG. 2.

The fraud detection circuit 120 is structured to enable various functionalities described herein. For example, in some instances, the fraud detection circuit 120 is structured to perform a fraud detection analysis, as described in detail below, with respect to FIG. 2. In some instances, the fraud detection circuit 120 is further structured to receive (e.g., automatically or nearly automatically upon various customer activities and transactions) or pull (e.g., upon a predetermined schedule) various customer activity information, customer transaction information, and/or customer account information from the account processing circuit 114, the account database 116, the transaction processing circuit 118, the fraud detection database 122, and/or the transfer service computing system 106 (e.g., a transfer service database 130) to enable the fraud detection analysis, as will also be described further below, with respect to FIG. 2.

The fraud detection database 122 is structured or configured to retrievably store various fraud detection information associated with customers and corresponding customer accounts held or otherwise maintained by the provider institution, as well as fraud detection information pertaining to potentially fraudulent sender and/or recipient identifying information. For example, if the fraud detection circuit 120 identifies a customer account held or otherwise maintained by the provider or a particular sender or recipient as potentially associated with fraudulent transactions, the fraud detection circuit 120 is structured to store associated customer account information and/or the potentially fraudulent sender or recipient identifying information within the fraud detection database 122. In these instances, the customer account information and/or the potentially fraudulent sender or recipient identifying information may be flagged as potentially fraudulent within the fraud detection database 122. Accordingly, in some instances, the fraud detection circuit 120 may additionally pull various fraud detection information from the fraud detection database 122 when performing the fraud detection analysis, as will be described further below, with respect to FIG. 2.

The customer device 104 is owned, operated, controlled, managed, and/or otherwise associated with a customer (e.g., a customer of the provider institution). In some embodiments, the customer device 104 may be or may comprise, for example, a desktop or laptop computer (e.g. a tablet computer), a smartphone, a wearable device (e.g., a smartwatch), a personal digital assistant, and/or any other suitable computing device. In the example shown, the customer device 104 is structured as a mobile computing device, namely a smartphone.

In some embodiments, the customer device 104 includes one or more I/O devices 124, a network interface circuit 126, and one or more customer client applications 128. Again, while the term “I/O” is used, it should be understood that the I/O devices 124 may be input-only devices, output-only devices, and/or a combination of input and output devices. In some instances, the I/O devices 124 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the customer to provide inputs (such as a touchscreen display, stylus, keyboard, force sensor for sensing pressure on a display screen, etc.). In some instances, the I/O devices 124 further comprise one or more user interfaces (devices or components that interface with the customer), which may include one or more biometric sensors (such as a fingerprint reader, a heart monitor that detects cardiovascular signals, face scanner, an iris scanner, etc.).

The network interface circuit 126 includes, for example, program logic and various devices (e.g., transceivers, etc.) that connect the customer device 104 to the network 108. The network interface circuit 126 facilitates secure communications between the customer device 104 and each of the provider institution computing system 102 and the transfer service computing system 106. The network interface circuit 126 also facilitates communication with other entities, such as other banks, settlement systems, and so on.

The customer device 104 stores in computer memory, and executes (“runs”) using one or more processors, various customer client applications 128, such as an Internet browser presenting websites, text messaging applications (e.g., for sending MMS or SMS to the provider institution computing system 102 and/or the transfer service computing system 106), and/or applications provided or authorized by entities implementing or administering any of the computing systems in computing environment 100.

For example, in some instances, the customer client applications 128 comprise a customer provider institution client application (e.g., a financial institution banking application) provided by and at least partly supported by the provider institution computing system 102. For example, in some instances, the customer client application 128 coupled to the provider institution computing system 102 may enable the customer to perform various customer activities (e.g., account management, account opening and/or closing actions, account withdrawals and deposits) and/or perform various transactions (e.g., the customer sending funds to a recipient, the customer receiving funds from a sender, etc.) associated with one or more customer accounts of the customer held at the provider institution associated with the provider institution computing system 102 (e.g., account opening and closing operations, fund transfers, etc.).

In some other instances, the customer client application 128 provided by the provider institution computing system 102 may additionally be coupled to the transfer service computing system 106 (e.g., via one or more application programming interfaces (APIs) and/or software development kits (SDKs)) to integrate one or more features or services provided by the transfer service computing system 106. For example, in some instances, the provider institution computing system 102 may integrate a transfer service provided by the transfer service computing system 106 for transferring funds between users of the transfer service using transfer service tokens, as will be described further below, into the customer client application 128. In some other instances, the transfer service computing system 106 may alternatively provide the transfer service via a separate customer client application 128.

Accordingly, the customer client applications 128 are structured to provide the customer with access to various services offered by the provider institution and/or the transfer service. In some embodiments, the customer client applications 128 are hard coded onto the memory of the customer device 104. In some embodiments, the customer client applications 128 are web-based interface applications, where the customer has to log onto or access the web-based interface before usage, and these applications are supported by a separate computing system comprising one or more servers, processors, network interface circuits, or the like (e.g., the provider institution computing system 102, the transfer service computing system 106), that transmit the applications for use to the customer device 104.

The transfer service computing system 106 is controlled by, managed by, owned by, and/or otherwise associated with a transfer service entity (e.g., Zelle®, Billpay, online wire transfer services) that is configured to enable real-time or nearly real-time transfers between users. As described herein and in one embodiment, the “transfer” is a payment or fund transfer. In some instances, the payment or fund transfer may include electronic or digital fund transfers.

In some instances, the transfer service entity may be a financial institution (e.g., a card network) or other entity that supports transfers across multiple different entities (e.g., across different financial institutions). In some instances, the transfer service entity may, for example, be an entity that is formed as a joint venture between banks and/or other entities that send and receive funds using the computing environment 100. As another example, the transfer service entity may be a third-party vendor. As still another example, the transfer service entity may be provided by the provider institution, such that the provider institution performs both the operations described herein as being performed by the provider institution computing system 102 and the operations described herein as being performed by the transfer service computing system 106.

In some embodiments, transfer service computing system 106 may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures. Although not specifically shown, it will be appreciated that the transfer service computing system 106 may include a network interface circuit, various databases (e.g., similar to the transfer service database 130), an account processing circuit, and other circuits in the same or similar manner to the other components of computing environment 100. In some instances, the network interface circuit may include user interface program logic configured to generate and present application pages, web pages, and/or various other data to users accessing the transfer service computing system 106 over the network 108.

The transfer service computing system 106 is configured to enable real-time or nearly real-time transfers between registered users of the transfer service. For example, in some instances, during a registration process, the transfer service computing system 106 is configured to receive one or more transfer service tokens (e.g., a Zelle® identifier), such as a phone number, an e-mail address, an alphanumeric tag, etc., to be associated with an entity (e.g., the customer or any other user) registering for the transfer service. During the registration process, the transfer service computing system 106 is further configured to receive various account information (e.g., a bank routing number, a bank account number) and identifying information (e.g., a name, a phone number, an e-mail address, a physical address) associated with the entity to be linked to the corresponding received transfer service token(s) for registering the entity with the transfer service.

Accordingly, in some instances, the transfer service computing system 106 is configured to receive a registration request from the provider institution computing system 102 and/or the customer device 104 to register the customer. In some instances, the registration request includes a desired transfer service token, the account information, and the identifying information associated with the customer. Upon receiving the registration request, the transfer service computing system 106 is configured to store the transfer service token, the account information, and the identifying information for the customer within a transfer service database 130 and to link the transfer service token to the account information and the identifying information within the transfer service database 130 to register the customer with the transfer service.

Once the transfer service token, the account information, and the identifying information for the biller and/or customer have been stored and linked within the transfer service database 130, the transfer service computing system 106 is configured to, upon receipt of a transfer request (e.g., received from the provider institution computing system 102 or the customer device 104), query the transfer service database 130 to retrieve the corresponding account information and identifying information associated with recipient and sender transfer service tokens included in the requested transfer. Once the corresponding account information is successfully retrieved by the transfer service computing system 106, the transfer service computing system 106 is configured to initiate a transfer (e.g., of funds) from an account associated with the sender to an account associated with the recipient.

As discussed above, the transfer service database 130 stores transfer service tokens, corresponding account information, and corresponding identifying information for various transfer service accounts that are maintained by the transfer service on behalf of its customers. The transfer service database 130 is configured to be used by the transfer service computing system 106 to enable the real-time or near real-time transfers discussed above.

In some instances, the transfer service computing system 106 is configured to provide (e.g., through its own client application or through integration with a client application of another entity, such as a banking application) at least some of the functionality depicted in the figures and described herein. For example, in some instances, as discussed above, at least some of the functionality performed by the transfer service computing system 106 is integrated within a banking application (e.g., one of the customer client applications 128) provided by the provider institution computing system 102 to the customer device 104. For example, in some instances, the transfer service computing system 106 includes one or more APIs and/or SDKs that securely communicate with the provider institution computing system 102 and allow for various functionality performed by the transfer service computing system 106 to be embedded within the customer client application 128 provided by the provider institution computing system 102 to the customer device 104.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

Referring to FIG. 2, a flow diagram of a method 200 for mitigating fraud using a data element analysis is shown, according to an example embodiment. Various operations of the method 200 may be conducted by the fraud mitigation computing environment 100 and particularly parts thereof (e.g., the provider institution computing system 102, the customer device 104, and the transfer service computing system 106).

As shown, the method 200 begins by the fraud detection circuit 120 receiving an action notification, at step 202. The fraud detection circuit 120 may receive the action notification from any one or more of the account processing circuit 114, the transaction processing circuit 118, the customer device 104, and/or the transfer service computing system 106. In some instances, the action notification may comprise a notification regarding a new customer attempting to open a new account with the provider institution (e.g., received from the account processing circuit 114). In some instances, the action notification may comprise a notification regarding an existing customer attempting to register a new transfer service account (e.g., received from the account processing circuit 114 and/or the transfer service computing system 106). In some instances, the action notification may comprise a notification regarding one or more customer transactions or transfer service fund transfers (e.g., received from the transaction processing circuit 118 and/or the transfer service computing system 106). In some instances, the action notification may comprise a notification regarding a claim of fraud submitted by a customer (e.g., received from the customer device 104). For example, in some instances, the customer client application 128 is structured to allow the customer to submit claims of fraud associated with particular transactions occurring on particular customer accounts via the customer device 104. In some instances, the action notification may comprise a notification regarding various other customer activities associated with new or existing customer accounts, as desired for a given application.

Once the fraud detection circuit 120 has received the action notification, at step 202, the fraud detection circuit 120 then obtains various user action information, at step 204. In some instances, the user action information obtained by the fraud detection circuit 120 is configured to allow the fraud detection circuit 120 to perform a fraud detection analysis to determine whether the action is potentially fraudulent. For example, in some instances, the user action information obtained by the fraud detection circuit 120 includes, for each of the relevant entities (e.g., the customer, the sender or recipient of funds in a given transaction or a transfer service fund transfer), one or more of a name of the relevant entity, an e-mail account associated with the relevant entity, a phone number associated with the relevant entity, an account tenure (e.g., an indication of how long the associated account has existed) associated with an account of the relevant entity, a transaction history (e.g., including both a number of transactions performed and an amount of funds transferred within those transactions) associated with the account of the relevant entity, a fraud claim history associated with the account of the relevant entity, a transfer service token (e.g., a phone number, an e-mail address, a tag) registered with the transfer service for the account of the relevant entity, a transfer service token type (e.g., consumer, small business), a transfer service token history (e.g., an indication of how long the transfer service token has been in existence) for the transfer service token, a transfer service history (e.g., an indication of how long the relevant entity has been utilizing the transfer service) of the relevant entity, a memo field value associated with a transfer service fund transfer (e.g., a message between the customer and the sender/recipient included with the transfer service fund transfer), or any other pertinent user action information.

In some instances, various user action information associated with a customer activity is provided to the fraud detection circuit 120 by the account processing circuit 114, the transaction processing circuit 118, the customer device 104, and/or the transfer service computing system 106 within the action notification. For example, as discussed above, in some instances, the account processing circuit 114 and/or the transaction processing circuit 118 are configured to identify customer accounts and/or sender/recipient accounts associated with the relevant customer activities and automatically pull various customer account information from the account database 116 and/or sender/recipient account information from the transfer service computing system 106 for inclusion in the action notification sent to the fraud detection circuit 120. Similarly, in some instances, the transfer service computing system 106 is configured to identify transfer service accounts associated with a relevant transfer service fund transfer and automatically pull various sender/recipient account information from the transfer service database 130 for inclusion in the action notification sent to the fraud detection circuit 120. In some instances, the customer client application 128 is configured to automatically provide various information associated with the customer and/or a given requested action along with the action notification provided to the fraud detection circuit 120.

In some other instances, the fraud detection circuit 120 is structured to pull the various user action information from the account processing circuit 114, the account database 116, the transaction processing circuit 118, the fraud detection database 122, the customer device 104, and/or the transfer service computing system 106. For example, in some instances, the fraud detection circuit 120 is structured to automatically pull the various user information upon receipt of an action notification. In some instances, the fraud detection circuit 120 is structured to pull various user action information according to a predetermined schedule (e.g., daily, weekly, monthly, annually).

In some instances, the fraud detection circuit 120 is structured to both receive various user action information from the account processing circuit 114, the transaction processing circuit 118, the customer device 104, and/or the transfer service computing system 106 and to automatically pull various additional user action information from the account database 116 and/or the fraud detection database 122.

Once the fraud detection circuit 120 has obtained the various user action information, at step 204, the fraud detection circuit 120 then performs a fraud detection analysis, at step 206, to determine whether the action is fraudulent or potentially fraudulent. In some embodiments, the fraud detection circuit 120 is configured to determine whether the action is fraudulent or potentially fraudulent by determining whether a data element analysis satisfies a fraud indicator condition (e.g., exceeds a fraud risk value threshold). For example, in some instances, the fraud detection circuit 120 is structured to perform the fraud detection analysis by parsing information associated with the action (e.g., token email, token phone number, etc.), weighing a variety of fraud risk data elements from the parsed information corresponding to the various obtained user action information, and determining whether the given action is fraudulent or potentially fraudulent based on the analysis of the parsed data elements.

The fraud risk data elements are predefined data elements that may be parsed from information associated with the action and/or otherwise be characteristics associated with the action that are retrieved or otherwise determined by the fraud detection circuit 120. For example, in some instances, the fraud risk data elements may include, for each of the relevant entities (e.g., the customer, the sender or recipient of funds in a given transaction or a transfer service fund transfer), one or more of an e-mail username value (e.g., the portion of an e-mail address preceding the “@” symbol) associated with a transfer service token, an e-mail domain value associated with the transfer service token (e.g., the portion of an e-mail address following the “@” symbol), a phone number associated with the transfer service token, a transfer service token type (e.g., consumer, small business) associated with the transfer service token, a transfer service token tenure (e.g., an indication of how long the transfer service token has been in existence), a memo field value associated with a transfer service fund transfer (e.g., the message included with the transfer service fund transfer between the customer and the sender/recipient, such as “pizza” or other message that accompanies the transaction), an account tenure associated with an account of the relevant entity (e.g., an indication of how long the associated account has existed), a transfer service tenure (e.g., an indication of how long the relevant entity has been utilizing the transfer service), a transaction count velocity (e.g., a rate/amount of transactions performed in a predefined time period) associated with the account of the relevant entity, a transaction amount velocity (e.g., a rate of an amount of funds transferred in a predefined time period) associated with the account of the relevant entity, a fraud claim velocity (e.g., a rate of fraud claims submitted in a predefined time period) associated with the account of the relevant entity, and/or any other relevant fraud risk data elements.

In one embodiment, the fraud detection circuit 120 determines an individual risk value or score for one or more of the fraud data risk elements discussed above. Further, the individual risk value or score may be determined for each of the fraud data elements in predefined order and one at a time. That way, fraud data elements that are more likely to indicate fraud are analyzed first, which may save computing resources due to not analyzing all of the potential data elements. In other embodiments, multiple fraud data elements are analyzed in parallel.

In some instances, a high risk value or score is indicative of a high risk factor, while a low risk value or score is indicative of a non-risky or low risk factor (i.e., factors that indicate the presence of fraud are “high risk factors” and the factors that do not indicate the presence of fraud are “low risk factors”).

In some instances, the fraud detection circuit 120 is structured to utilize historical fraud information (e.g., retrieved from the account database 116, the fraud detection database 122, or in any other database associated with the provider institution computing system 102) to determine the individual risk value or score for one or more fraud data risk elements specific to a given action. For example, with respect to the risk value or score for the e-mail username value or another transfer service token value, such as an alphanumeric transfer tag, associated with the transfer service token of the relevant entity, in some instances, the fraud detection circuit 120 is structured to analyze the e-mail username (e.g., the portion of the e-mail address preceding the “@” symbol) or the alphanumeric transfer tag associated with the transfer service token to identify whether any portion of the e-mail username or alphanumeric tag matches any of a variety of predefined fraud risk keywords (e.g., stored in and retrieved from the fraud detection database 122). In some instances, the fraud risk keywords correspond to words, phrases, word permutations, and/or phrase permutations that have historically been used by and/or that may be used now or in the future by fraudsters within e-mail usernames or alphanumeric transfer tags to trick innocent customers into believing that the provided e-mail username or alphanumeric transfer tag associated with the transfer service token to be used for payment is coming from a legitimate source. Often, fraudsters will use the same fraud risk keywords within a variety of fraudulent e-mail usernames, and will merely change a suffix or a prefix of the e-mail username for each new e-mail address or for the alphanumeric transfer tag for each new transfer service token.

Example fraud risk keywords may include, but are not limited to, transaction-related words (e.g., “bill,” “refund,” “pay,” “validation,” “code,” “fraud”), known company or entity names (e.g., “Wells Fargo”), governmental agency names (e.g., “IRS,” “treasury”), traditional business words (e.g., “department,” “billing,” “accounting”), or a variety of other keywords or permutations (e.g., using “frd” instead of “fraud” or using “acct” instead of “account”) that may be intentionally used by fraudsters to deceive innocent customers. It will be appreciated that, in some instances, the fraud risk keywords may be words in languages other than English (e.g., Spanish, German, etc.), as desired for a given application.

In some instances, the fraud risk keywords and associated permutations may be manually provided to the provider institution computing system 102 via the I/O devices 110. In some other instances, the fraud detection circuit 120 is configured to automatically determine the fraud risk keywords and associated permutations based on e-mail usernames associated with transfer service tokens used in past fraudulent transactions (e.g., stored in and retrieved from the fraud detection database 122). For example, in some instances, the fraud detection circuit 120 is configured to analyze historical fraudulent transaction information (e.g., stored in and retrieved from the fraud detection database 122) and identify keywords within e-mail usernames associated with transfer service tokens that have been utilized in fraudulent transactions. In some instances, the fraud detection circuit 120 is structured to analyze the historical fraudulent transaction information and identify the keywords within the e-mail usernames using one or more artificial intelligence or machine-learning models.

In some instances, each fraud risk keyword may have an associated corresponding fraud risk keyword value and, particularly, weight. In some instances, the fraud risk keyword weight for each fraud risk keyword may correspond to a frequency with which the specific fraud risk keyword has historically been used within e-mail usernames associated with transfer service tokens utilized in fraudulent transactions. For example, the word “billing” may be utilized in a relatively high number of fraudulent transactions than innocent or non-fraudulent transactions, and thus may be given a high fraud risk keyword weight or value. However, in some instances, a given keyword may be utilized in some fraudulent transactions, but may also be part of another word or phrase that is likely not fraudulent. For example, the word “dispute” may be utilized in some fraudulent transaction, but in some instances, the word “undisputed” may be innocently utilized within a variety of e-mail usernames (e.g., “UndisputedKing103”). Accordingly, keywords that are regularly utilized within e-mail usernames of both fraudsters and innocent customer may be given a lower fraud risk keyword weight given the inability for them to indicate fraud in a more likely than not analysis. Further, in some instances, fraud risk keywords and their corresponding permutations may each have their own associated individual fraud risk keyword weight, which may each be individually based on their historical use in fraudulent transactions.

In some instances, the fraud detection circuit 120 is configured to utilize the fraud risk keyword weights associated with any fraud risk keywords identified within a given e-mail username to determine a risk value or score associated with the e-mail username value. For example, the fraud detection circuit 120 may determine the risk value or score by aggregating the individual fraud risk keyword weights together. As a specific example, the email username may be “bankbilling12,” where the first fraud risk keyword is “bank” and the second fraud risk keyword is “billing.” The first fraud risk keyword may be assigned or determined to have a weight of 5 out of 100 and the second fraud risk keyword may be assigned or determined to have a weight of 15 out of 100. In this example, the overall risk value or score for the e-mail username value may be 20 out of 100. It will be appreciated that these weights and risk values or scores (e.g., scores out of 100) are provided as examples and are in no way meant to be limiting. In some instances, a variety of other weights and risk values or scores may be utilized, as desired for a given application.

In some instances, the fraud detection circuit 120 is further configured to place a higher risk value or score on an e-mail username using multiple fraud risk keywords than the cumulative total of the individual fraud risk keyword weights. For example, if a given e-mail username uses multiple fraud risk keywords, the fraud detection circuit 120 may apply a multiplicative factor to the cumulative weight total of the various fraud risk keywords (e.g., by multiplying the cumulative weight total by the multiplicative factor) to calculate the risk value or score. As a specific example, in the scenario described above, where the e-mail username is “bankbilling12,” the first fraud risk keyword is “bank” and has a weight of 5 out of 100, and the second fraud risk keyword is “billing” and has a weight of 15 out of 100, the fraud detection circuit 120 may add the weights together (e.g., 20 out of 100) to determine the cumulative weight total and then apply a two-keyword multiplicative factor (e.g., 1.2) to the cumulative weight total to calculate the risk value or score (e.g., 24 out of 100). In some instances, the multiplicative factor may be higher for each additional fraud risk keyword utilized in the e-mail username (e.g., a three-keyword multiplicative factor may be 1.5, a four-keyword multiplicative factor may be 2, etc.).

In some instances, the fraud detection circuit 120 is further configured to factor in an order of the fraud risk keywords appearing within the e-mail username. For example, in some instances, a first keyword followed by a second keyword within an e-mail username may be associated with a higher number of fraudulent transactions than the second keyword followed by the first keyword. Accordingly, in some instances, if a given e-mail username includes both the first keyword and the second keyword, the fraud detection circuit 120 is configured to apply a higher risk value or score to the e-mail username if the first keyword is followed by the second keyword, as compared to a scenario where the second keyword is followed by the first keyword. As a specific example, referring again to the scenario where the e-mail username is “bankbilling12,” the first fraud keyword is “bank” and has a weight of 5 out of 100, and the second fraud risk keyword is “billing” and has a weight of 15 out of 100, the fraud detection circuit 120 may add a keyword order weight (e.g., 5 out of 100) to the cumulative weight total when “bank” precedes “billing” within the e-mail username, resulting in a higher risk value or score (e.g., 25 out of 100), but may not add the keyword order weight to the cumulative total when “bank” follows “billing” within the e-mail username, resulting in a lower risk value or score (e.g., 20 out of 100).

With respect to the risk value or score for the e-mail domain value associated with the transfer service token of the relevant entity, in some instances, the fraud detection circuit 120 is structured to determine whether the e-mail domain value (e.g., the portion of the e-mail address following the “@” symbol) matches any of a variety of potentially risky e-mail domains (e.g., stored in and retrieved from the fraud detection database 122). For example, in some instances, the potentially risky e-mail domains may be manually provided to the provider institution computing system 102 via the I/O devices 110. In some other instances, the fraud detection circuit 120 is structured to analyze historical fraudulent transaction information (e.g., stored in and retrieved from the fraud detection database 122) and identify potentially risky e-mail domains based on e-mail domains associated with transfer service tokens that have been utilized in fraudulent transactions. For example, in some instances, the fraud detection circuit is structured to analyze the historical fraudulent transaction information and identify the potentially risky e-mail domains using one or more artificial intelligence or machine-learning models.

Similar to the fraud risk keywords described above, each potentially risky e-mail domain may have an associated e-mail domain weight based on the frequency with which the specific e-mail domain has historically been associated with transfer service tokens utilized in fraudulent transactions. For example, an e-mail domain that has frequently been used in fraudulent transactions and is otherwise not frequently used for innocent transactions (e.g., “paybillnow.com”) may be given a high risk e-mail domain weight. On the other hand, an e-mail domain that is regularly utilized for both fraudulent and innocent transactions (e.g., “gmail.com”) may be given a lower risk e-mail domain weight.

In some instances, a given e-mail domain may be flagged based on a weighting rule provided by an operator of the provider institution (e.g., an employee of the provider institution) via the I/O devices 110. For example, if a given e-mail domain (e.g., “account.com”) has only been used for fraudulent transactions (or if an overwhelming majority of the transaction using the e-mail domain have been fraudulent), the operator of the provider institution may set a weighting rule to automatically max-out the e-mail domain weight for that e-mail domain, such that any transactions or activities using that e-mail domain are automatically flagged as fraudulent.

In some instances, the fraud detection circuit 120 is structured to determine the risk value or score for the e-mail domain value solely based on the e-mail domain weight. In some other instances, the fraud detection circuit 120 may factor into the risk value or score for the e-mail domain whether the corresponding e-mail username includes any fraud risk keywords. For example, if a moderately risky e-mail domain is used in conjunction with a moderately risky fraud risk keyword, the fraud detection circuit 120 may apply a multiplicative factor to the risk value or score for the e-mail domain.

With respect to the risk value or score for the phone number associated with the transfer service token of the relevant entity, in some instances, the fraud detection circuit 120 is structured to utilize a third-party identity verification service (e.g., Prove Identity™) to analyze the phone number to determine the risk value or score. For example, in some instances, the fraud detection circuit 120 is structured to transmit the phone number associated with the relevant entity to a third-party identity verification service system (e.g., via the network 108) that then provides the fraud detection circuit 120 with various information associated with that phone number. For example, in some instances, the third-party identity verification system may provide the fraud detection circuit 120 with a telephone service carrier associated with the phone number, a name associated with the phone number, a type of phone associated with the phone number (e.g., pre-paid vs. non-pre-paid), an indication of whether the phone number is associated with a personal phone or a corporate phone, an indication of whether information associated with the phone number is not available via the third-party identity verification system, or any other pertinent information.

Accordingly, in some instances, the fraud detection circuit 120 is configured to compare the information received from the third-party identity verification system to the corresponding information associated with the relevant entity. For example, the fraud detection circuit 120 may determine whether the name of the relevant entity (e.g., the customer, sender, or recipient) matches or substantially matches the name received from the third-party identity verification system. If the name matches or partially matches, the fraud detection circuit 120 may lower the risk value or score associated with the phone number. However, if the name does not match, the fraud detection circuit 120 may raise the risk value or score associated with the phone number. Further, in some instances, the fraud detection circuit 120 may give a higher risk value or score to the phone number if it is associated with a pre-paid phone. Additionally, the fraud detection circuit 120 may give a higher risk value or score to the phone number if the relevant information associated with the phone number is not available via the third-party identity verification system. Further, in some instances, the fraud detection circuit 120 may provide a higher or lower risk value or score to the phone number based on whether the phone number is associated with a personal phone or a corporate phone in conjunction with other aspects of the transaction aligning with a personal or corporate transaction. For example, if the phone number is associated with a personal phone, but the transfer service token is associated with an e-mail username or e-mail domain that appears to be business related, the fraud detection circuit 120 may give the phone number a higher risk value or score based on this mismatch between the phone type and the e-mail username or e-mail domain associated with the transfer service token.

With respect to the risk value or score for the transfer service token type associated with the transfer service token of the relevant entity, in some instances, the fraud detection circuit 120 may give a higher or lower risk value or score to the transfer service token type based on whether the transfer service token type matches other characteristics of the transaction. For example, if a given transfer service token has a consumer transfer service token type, but the transfer service token is associated with an e-mail username or e-mail domain that appears to be business related, the fraud detection circuit 120 may give the transfer service token type a higher risk value or score based on this mismatch between the transfer service token type and the e-mail username or e-mail domain associated with the transfer service token.

With respect to the risk value or score for the memo field value associated with a transfer service fund transfer, the fraud detection circuit 120 may be configured to analyze the memo field value to determine if potentially predefined fraudulent words, phrases, and/or emojis are utilized. For example, in some instances, the fraud detection circuit 120 is structured to analyze historical fraudulent transaction information (e.g., stored in and retrieved from the fraud detection database 122 or received from the transfer service computing system 106) and identify potentially fraudulent words (e.g., “refund”), phrases (e.g., “airline miles,” “paying taxes”), and/or emojis (e.g., a cash emoji) that have frequently been used in fraudulent transactions. In some instances, the fraud detection circuit 120 is structured to analyze the historical fraudulent transaction information and identify the fraudulent words, phrases, and/or emojis using one or more artificial intelligence or machine-learning models.

In some instances, similar to the fraud risk keywords discussed above, each potentially fraudulent word, phrase, and/or emoji may have an associated fraud risk weight. Accordingly, the fraud detection circuit 120 may similarly determine the overall risk value or score for the memo field value by aggregating the various fraud risk weights, by placing a higher risk value or score on a memo field including multiple potentially fraudulent words, phrases, and/or emojis than the cumulative total of their individual fraud risk weights (e.g., using a similar multiplicative factor), and/or by taking into account an order in which the potentially fraudulent words, phrases, and/or emojis appear within the memo field (e.g., using a similar order-based multiplicative factor).

With respect to the risk values or scores for the account tenure, the transfer service tenure, and the transfer service token tenure, the fraud detection circuit 120 is structured to apply a lower risk value or score to an account that has existed for an extended period of time, a transfer service token that has existed for an extended period of time, and/or a user that has been utilizing the transfer service for an extended period of time, as compared to an account that has only existed for a short period of time, a transfer service token that was recently created, and/or a user that has just begun utilizing the transfer service.

In some instances, with respect to the risk value or score for the transfer service token tenure, the fraud detection circuit 120 may further take into account various transfer service token information obtained from the transfer service computing system 106 pertaining to the transfer service token utilized for a given action. For example, if the transfer service token has existed for a long period of time (more than a predefined length, such as three years, two years, etc.), but has switched between multiple other providers (e.g., other financial institutions) or that multiple other providers have purposefully unlinked the transfer service token from their customers' accounts (e.g., likely in response to fraudulent behavior), the fraud detection circuit 120 may apply a higher risk value or score to the transfer service token tenure. Specifically, this scenario may be indicative of a fraudster attempting to “token flip” between different financial institutions to avoid detection.

With respect to the transaction count velocity, the transaction amount velocity, and the fraud claim velocity associated with the account of the relevant entity, in some instances, the fraud detection circuit 120 is structured to apply a higher risk value or score to a high transaction count velocity (e.g., a high number of transactions on an account within a short period of time), a high transaction amount velocity (e.g., a high amount of funds transferred into or out of an account within a short, predetermined period of time), and/or a high fraud claim velocity (e.g., a high number of fraud claims on an account within a short, predetermined period of time), as compared to a low transaction count velocity, a low transaction amount velocity, and/or a low fraud claim velocity. For example, the amount of transactions on the account or funds transferred into or out of the account may be monitored over a predetermined period of time of several hours, one day, several days, a week, several weeks, etc. In some instances, a predetermined number of fraud claims on a particular account within a particular time span may automatically flag a particular account as having fraudulent activity thereon.

Once the fraud detection circuit 120 has determined an individual risk value or score for each of the various fraud data risk elements, as discussed above, the fraud detection circuit 120 may then utilize the various risk values or scores according to one or more predefined processes or techniques to complete the fraud detection analysis. For example, in some instances, the fraud detection circuit 120 may complete the fraud detection analysis by applying one or more fraud detection rules to the individual risk values or scores.

In some instances, the fraud detection rules are stored within the fraud detection database 122 and are configured to be utilized by the fraud detection circuit 120 to assess the individual risk values or scores to detect fraudulent or potentially fraudulent actions. For example, in some instances, the various fraud detection rules may be manually provided by a user via the I/O devices 110. In other instances, the fraud detection circuit 120 is structured to analyze historical fraudulent transaction information and determine the various fraud detection rules. For example, in some instances, the fraud detection circuit 120 is structured to determine the various fraud detection rules based on the historical fraudulent transaction information using one or more artificial intelligence or machine-learning models.

For example, in some instances, the fraud detection rules may indicate that, if any individual risk value or score is above an individual risk value threshold or score threshold, the fraud detection circuit 120 should flag the corresponding action as potentially fraudulent. In some instances, the fraud detection rules may further indicate that, if a cumulative total of one or more predefined individual risk values or scores exceeds a cumulative total threshold, the fraud detection circuit 120 flags the corresponding action as potentially fraudulent.

In some instances, the fraud detection rules may further specify a weighting scheme to utilize in conjunction with the individual risk values or scores associated with each fraud risk data element. For example, in these instances, the fraud detection rules may specify different weight factors to apply to each individual risk value or score based on a level of correlation between the corresponding fraud risk data element risk value or score and a likelihood of fraud. Thus, in some instances, the fraud detection circuit 120 may utilize equation (1), shown below, to calculate a weighted overall risk value or score of the various individual risk values or scores:

DERS₁×WF₁+DERS₂×WF₂+ . . . DERS_{N}×WF_{N}=WORS (1)

where DERS₁ is a risk value or score for a first data element; WF₁ is a weight factor for the first data element; DERS₂ is a risk value or score for a second data element; WF₂ is a weight factor for the second data element; DERS_{N} is a risk value or score for an N^{th} data element; WF_{N} is a weight factor for the N^{th} data element; N is the total number of data elements; and WORS is the weighted overall risk value or score.

In some instances, the fraud detection rules may indicate that, if the weighted overall risk value or score exceeds a predefined weighted overall risk value threshold or score threshold, the fraud detection circuit 120 flags the corresponding action as potentially fraudulent.

In some instances, some of the fraud risk data elements mentioned above may only be utilized to assess the potential fraud risk for certain types of actions (e.g., fund transfers). Further, in some instances, additional fraud risk data elements not mentioned above may be utilized. Accordingly, it will be appreciated that various subsets of the fraud risk data factors, as well as various additional fraud risk data factors, may be utilized within the fraud detection analysis described above, as desired for a given application.

Once the fraud detection circuit 120 has performed the fraud detection analysis, at step 206, the fraud detection circuit 120 then determines whether potential fraud has been detected, at step 208, based on the fraud detection analysis and corresponding fraud detection rules. If the fraud detection circuit 120 determines that potential fraud has been detected, at step 208, the fraud detection circuit 120 performs one or more fraud mitigation actions, at step 210. For example, in some instances, specific fraud detection rules may indicate which fraud mitigation actions to take depending on the various risk values or scores determined for the different fraud risk data elements discussed above.

For example, in the context of a customer attempting to open a new customer account, if the fraud detection circuit 120 determines that potential fraud has been detected, the fraud detection circuit 120 may, based on the fraud detection analysis, prevent the customer from opening the new customer account, prevent the customer from registering a particular e-mail address with the new customer account, prevent the customer from registering a particular phone number with the new customer account, prevent the customer from using a particular e-mail address or phone number to register for a new transfer service token to be linked to the new customer account, and/or perform one or more additional customer validation operations.

In the context of a customer attempting to register for a new transfer service token using a new e-mail address or phone number, if the fraud detection circuit 120 determines that potential fraud has been detected, the fraud detection circuit 120 may, based on the fraud detection analysis, prevent the user from registering for the new transfer service token using the new e-mail address or phone number and/or perform one or more additional customer validation operations.

In the context of a customer send transaction (e.g., if the customer is attempting to send funds to another person), if the fraud detection circuit 120 determines that potential fraud has been detected, the fraud detection circuit 120 may, based on the fraud detection analysis, block the transaction, flag the transaction action for further review (e.g., by generating a notification to be displayed to a user via the I/O device or to be sent to the customer device 104 to be viewed by the customer), restrict a customer account (or recipient account) associated with the transaction (e.g., suspend or remove account action capabilities, only allow low-dollar transactions), warn the customer about the potentially fraudulent action via a warning message transmitted to the customer device 104 (e.g., “Do you really want to irrevocably send funds to this person?” “This transaction may be fraudulent. Is this the first time you're sending to this person?”), and/or shut down the customer account.

In the context of a customer receive transaction (e.g., if the customer is receiving funds from another person), if the fraud detection circuit 120 determines that potential fraud has been detected, the fraud detection circuit 120 may, based on the fraud detection analysis, similarly block the transaction, flag the transaction for further review, restrict a customer account (or sender account) associated with the transaction, and/or shut down the customer account.

In some instances, upon confirming a particular fraudulent action as fraudulent, the fraud detection circuit 120 is further structured to store associated fraud detection information pertaining to the confirmed fraudulent action (e.g., customer information and/or account information associated with the fraudulent action) within the fraud detection database 122 and to send the fraud detection information to the transfer service computing system 106 to be stored within the transfer service database 130 and/or to another centralized entity to enable the fraud detection information to be utilized to protect users throughout a larger transaction network.

If the provider institution computing system 102 determines that potential fraud has not been detected, at step 208, the provider institution computing system 102 allows the action to proceed, at step 212.

As referenced above, in some instances, the fraud detection circuit 120 is structured to automatically determine the various fraud detection rules utilized in the fraud detection analysis described above. In some instances, the fraud detection circuit 120 is configured to continuously update the fraud detection rules, the weights (e.g., keyword weights), the risk values or scores, etc. utilized in the fraud detection analysis based on new confirmed fraudulent action information associated with accounts held at the provider institution computing system 102, accounts held at the transfer service computing system 106, or accounts held at various other provider institutions (e.g., which may be retrieved by the fraud detection circuit 120 via the network 108).

For example, in some instances, in response to a given event that is likely associated with fraudulent activity on an account (e.g., the customer reports a claim of fraud, the account receives an abnormally large deposit, the account goes negative), the fraud detection circuit 120 is structured to confirm whether the activity was, in fact, fraudulent (e.g., by contacting the customer, having a user associated with the provider institution perform one or more validation checks). If the fraud detection circuit 120 determines that the action was fraudulent, the fraud detection circuit 120 is configured to perform the appropriate fraud mitigation actions, as discussed above, to add the additional confirmed fraudulent action information to the fraud detection database 122, and to send the additional confirmed fraudulent action information to the transfer service computing system 106 and/or another centralized entity.

Additionally, once the new confirmed fraudulent action information is added to the fraud detection database 122, the fraud detection circuit 120 is configured to re-evaluate the various fraud detection rules utilized in the fraud detection analysis. For example, based on additional confirmed fraudulent action information added over time, various fraud detection rules, weights, and risk values or scores may be continuously updated to ensure that the fraud detection analysis is configured to detect the up-to-date fraud techniques being utilized by fraudsters. In some instances, this re-evaluation process may include re-training or continuously training one or more artificial intelligence or machine-learning models of the fraud detection circuit 120 configured to determine the various fraud detection rules, weights, and risk values or scores.

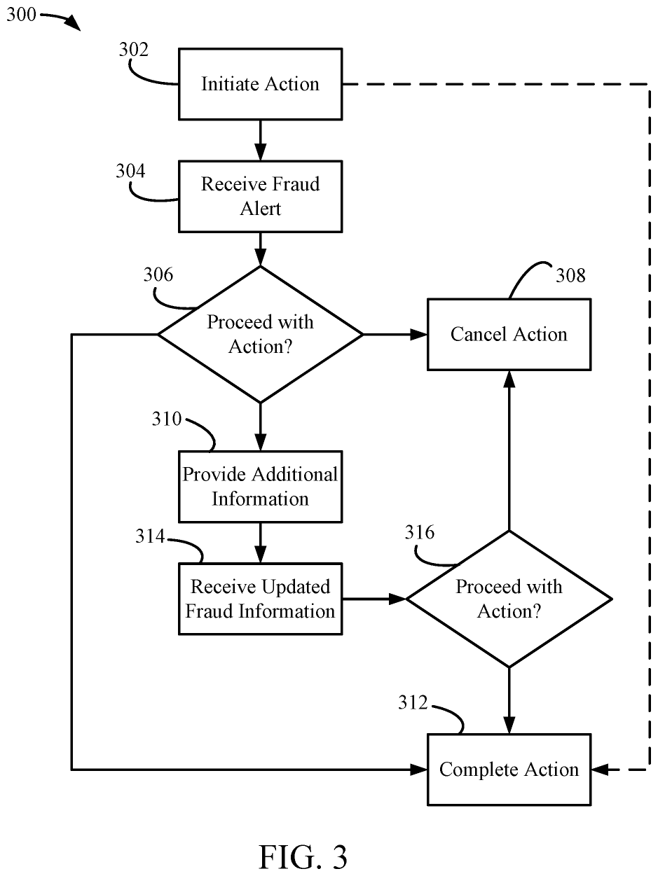

Referring to FIG. 3, a flow diagram of a method 300 for a customer attempting a potentially fraudulent action is shown, according to an example embodiment. Various operations of the method 300 may be conducted by the fraud mitigation computing environment 100 and particularly parts thereof (e.g., the provider institution computing system 102, the customer device 104, and the transfer service computing system 106).

As shown, the method 300 begins by the customer initiating an action, at step 302. For example, in some instances, the action may be the customer attempting to initiate or authorize a transfer to an account of a separate person or other entity. In some instances, the customer may (e.g., via the customer client application 128) attempt to initiate or authorize a transfer of resources to an account associated with a recipient transfer service token (e.g., an e-mail address, a phone number, an alphanumeric tag associated with the recipient transfer service token). In some other instances, the customer may attempt to initiate a variety of other actions, as described herein.

Accordingly, upon the customer initiating the action, at step 302, and in accordance with the method 200 described above, the fraud detection circuit 120 automatically receives an action notification associated with the customer-initiated action (e.g., via customer device 104 over the network 108), obtains various user action information, and determines whether the customer-initiated action is fraudulent. If the fraud detection circuit 120 determines that the customer-initiated action is not fraudulent, the customer-initiated action may simply be completed as requested, at step 316 (as indicated by the dashed line connecting step 302 to step 316).

Alternatively, if the fraud detection circuit 120 determines that the customer-initiated action is fraudulent, the fraud detection circuit 120 sends and the customer receives a fraud alert via the customer device 104, at step 304. For example, in some instances, the fraud alert may be transmitted to the customer device 104 as a text message, a pop-up notification, a splash page, or other graphical user interface.

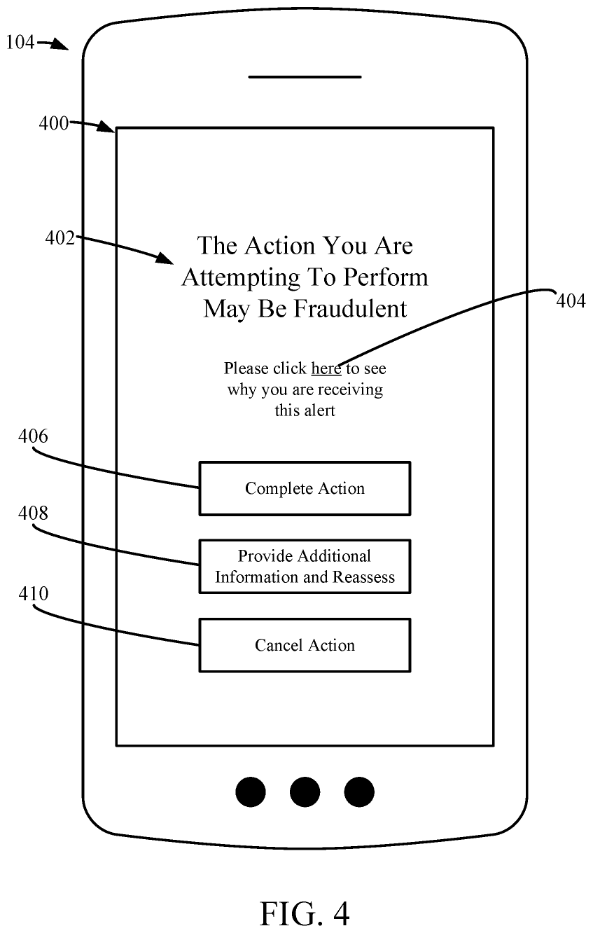

Referring now to FIG. 4, an example of a potential graphical user interface which may be presented on the customer device 104 by one of the customer client applications 128 (e.g., a banking application, a transfer service application) in response to the fraud detection circuit 120 determining that a particular attempted action is fraudulent is shown. This is a representative, non-limited example interface, and does not necessarily include all potential functionality of various embodiments. Similarly, not all the functionality depicted is necessarily required in all embodiments.

As mentioned above, FIG. 4 shows a user interface 400 that may be provided to a customer in response to the fraud detection circuit 120 determining that a particular attempted action is fraudulent. As shown, the user interface 400 provides an indication 402 that the attempted action is potentially fraudulent. In some embodiments, the user interface 400 further includes a link 404 configured to navigate the user to an information page providing additional information pertaining to why the action has been flagged as potentially fraudulent. For example, in some instances, the information page may provide the customer with information such as the individual risk values or scores or combination of individual risk values or scores that led to the action being flagged as fraudulent.

In some embodiments, the user interface 400 may further include a plurality of action selection buttons. For example, as depicted in FIG. 4, in some instances, the action selections buttons include a complete action button 406, an additional validation button 408, and a cancel action button 410. The complete action button 406 is configured to allow the customer to proceed with completing the action as requested. The additional validation button 408 is configured to navigate the customer to a validation page where the customer may enter one or more additional pieces of information relating to the requested action. Upon receipt of the additional pieces of information, the fraud detection circuit 120 reassesses the likelihood of the requested action being fraudulent in light of the new information. Accordingly, the fraud detection circuit 120 may provide the customer with a subsequent notification indicating that the requested action is still likely fraudulent or that, based on the new information, the requested action is no longer flagged as being potentially fraudulent. The cancel action button 410 is configured to allow the customer to cancel the action as requested.

With reference again to FIG. 3, upon receiving the fraud alert, at step 304, the customer then decides how to proceed, at step 306. For example, the customer may choose to cancel the action (e.g., by selecting the cancel action button 410 using the customer device 104), at step 308, to provide additional validation information (e.g., by selecting the additional validation button 408 using the customer device 104), at step 310, or to complete the action as-is (e.g., by selecting the complete action button 406 using the customer device 104), at step 312. If the customer decides, at step 306, to cancel the action, at step 308, the fraud detection circuit 120 instructs or otherwise causes the account processing circuit 114, the transaction processing circuit 118, or, in some instances, the transfer service computing system 106 to cancel the action, such that the action is not authorized.

If the customer decides to provide additional information, at step 310, the fraud detection circuit 120 receives additional information from the customer (e.g., provided via the customer device 104) and reassesses (e.g., in line with the process discussed above, with reference to the method 200) the likelihood of the requested action being fraudulent in light of the additional information. The fraud detection circuit 120 then generates updated fraud information indicating whether the requested action is still likely fraudulent or no longer flagged as being potentially fraudulent and transmits the updated fraud information to the customer device 104. Accordingly, the customer receives (e.g., via the customer device 104) the updated fraud information and decides, at step 306, whether to cancel the action, at step 308, or complete the action, at step 312.

If the customer decides, at step 306, to complete the action as-is, at step 312, the fraud detection circuit 120 instructs or otherwise causes the account processing circuit 114, the transaction processing circuit 118, or, in some instances, the transfer service computing system 106 to proceed with the action and that the action has been authorized by the customer.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include a general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
receiving, by at least one processing circuit of a provider computing system associated with a provider institution, an action notification regarding an action associated with an account held by a customer at the provider institution;
obtaining, by the at least one processing circuit, user action information associated with the action;
performing, by the at least one processing circuit, a fraud detection analysis based on the user action information, the fraud detection analysis comprising generating a plurality of individual risk values associated with a plurality of fraud data risk elements based on the user action information;
determining, by the at least one processing circuit, that the action is fraudulent based on the plurality of individual risk values associated with the plurality of fraud data risk elements; and
performing, by the at least one processing circuit, a fraud mitigation action based on determining that the action is fraudulent.

2. The method of claim 1, wherein determining that the action is fraudulent comprises determining that one of the individual risk values of one of the fraud data risk elements exceeds an individual risk value threshold or a cumulative total of the plurality of individual risk values exceeds a cumulative total threshold.

3. The method of claim 1, wherein the individual risk values are weighted based on a level of correlation between the corresponding individual risk values and a likelihood of fraud and determining that the action is fraudulent comprises determining that an aggregated weighted overall risk value exceeds a weighted overall risk value threshold.

4. The method of claim 1, wherein one fraud data risk element is an e-mail username or a transfer tag associated with the action and generating the individual risk value for the e-mail username or the transfer tag comprises:
identifying, by the at least one processing circuit, one or more fraud risk keywords within the e-mail username or the transfer tag;
determining, by the at least one processing circuit, a fraud risk keyword value for each of the one or more fraud risk keywords; and
aggregating, by the at least one processing circuit, the fraud risk keyword values for each of the one or more fraud risk keywords.

5. The method of claim 4, wherein the fraud risk keywords include one or more of transaction-related words, known company or entity names, governmental agency names, or business-related words.

6. The method of claim 4, wherein the fraud risk keyword value for each of the one or more fraud risk keywords is determined based on a frequency with which each fraud risk keyword has been used in fraudulent actions.

7. The method of claim 4, wherein the one or more fraud risk keywords comprise a plurality of fraud risk keywords and, wherein generating the individual risk value for the e-mail username or the transfer tag further comprises:
aggregating, by the at least one processing circuit, the fraud risk keyword values for each of the plurality of fraud risk keywords; and
applying, by the at least one processing circuit, a multiplicative factor to an aggregated total of the fraud risk keyword values based on there being multiple fraud risk keywords within the e-mail username or the transfer tag.

8. The method of claim 1, wherein the action is a transfer request including a memo field and one fraud data risk element is the memo field of the transfer request and the individual risk value is determined based on the memo field of the transfer request including one or more predefined words, phrases, or emojis, the one or more predefined words, phrases, or emojis being used in at least one fraudulent transaction.

9. The method of claim 1, wherein one fraud data risk element is one of a transaction count velocity or a transaction amount velocity of the account associated with the action and the individual risk value is determined, by the at least one processing circuit, based on one of a number of transactions on the account within an amount of time or an amount of resources transferred into or out of the account within an amount of time.

10. The method of claim 1, wherein the fraud mitigation action comprises one or more of preventing the customer from opening a new customer account, preventing the customer from registering an e-mail address with an opened new customer account, preventing the customer from registering a phone number with the opened new customer account, preventing the customer from using an e-mail address or a phone number to register for a new transfer service token, or performing an additional customer validation operation.

11. A provider computing system comprising:
one or more processing circuits including one or more processors and one or more memories having instructions stored thereon that, when executed by the one or more processors, cause the one or more processors to:
receive an action notification regarding a transfer request associated with an account held by a customer at a provider institution;
obtain user action information associated with the transfer request;
perform a fraud detection analysis based on the user action information, the fraud detection analysis comprising generating a plurality of individual risk values associated with a plurality of fraud data risk elements based on the user action information;
determine that the transfer request is fraudulent based on the plurality of individual risk values associated with the plurality of fraud data risk elements; and
perform a fraud mitigation action based on determining that the transfer request is fraudulent.

12. The provider computing system of claim 11, wherein determining that the transfer request is fraudulent comprises determining that one of the individual risk value of one of the fraud data risk elements exceeds an individual risk value threshold or a cumulative total of the plurality of individual risk values exceeds a cumulative total threshold.

13. The provider computing system of claim 11, wherein the individual risk values are weighted based on a level of correlation between the corresponding individual risk value and a likelihood of fraud and determining that the transfer request is fraudulent comprises determining that an aggregated weighted overall risk value exceeds a weighted overall risk value threshold.

14. The provider computing system of claim 11, wherein one fraud data risk element is an e-mail username or a transfer tag associated with the transfer request and generating the individual risk value for the e-mail username or the transfer tag comprises:
identifying one or more fraud risk keywords within the e-mail username or the transfer tag;
determining a fraud risk keyword value for each of the one or more fraud risk keywords; and
aggregating the fraud risk keyword values for each of the one or more fraud risk keywords.

15. The provider computing system of claim 14, wherein the one or more fraud risk keywords comprise a plurality of fraud risk keywords and, wherein generating the individual risk value for the e-mail username or the transfer tag further comprises:
aggregating the fraud risk keyword values for each of the plurality of fraud risk keywords; and
applying a multiplicative factor to an aggregated total of the fraud risk keyword values based on there being multiple fraud risk keywords within the e-mail username or the transfer tag.

16. A non-transitory computer-readable medium having instructions stored thereon that, when executed by at least one processing circuit of a provider computing system associated with a provider institution, cause operations comprising:
receiving an action notification regarding an action associated with an account held by a customer at the provider institution;
obtaining user action information associated with the action;
performing a fraud detection analysis based on the user action information, the fraud detection analysis comprising generating a plurality of individual risk values associated with a plurality of fraud data risk elements based on the user action information;
determining that the action is fraudulent based on the plurality of individual risk values associated with the plurality of fraud data risk elements; and
performing a fraud mitigation action based on determining that the action is fraudulent.

17. The non-transitory computer-readable medium of claim 16, wherein the individual risk values are weighted based on a level of correlation between the corresponding individual risk value and a likelihood of fraud and determining that the action is fraudulent comprises determining that an aggregated weighted overall risk value exceeds a weighted overall risk value threshold.

18. The non-transitory computer-readable medium of claim 16, wherein the action is a transfer request including a memo field and one fraud data risk element is the memo field of the transfer request and the individual risk value is determined based on the memo field of the transfer request including one or more predefined words, phrases, or emojis, the one or more predefined words, phrases, or emojis being used in at least one fraudulent transaction.

19. The non-transitory computer-readable medium of claim 16, wherein one fraud data risk element is one of a transaction count velocity or a transaction amount velocity of the account associated with the action and the individual risk value is determined based on one of a number of transactions on the account within an amount of time or an amount of resources transferred into or out of the account within an amount of time.

20. The non-transitory computer-readable medium of claim 16, wherein the fraud mitigation action comprises one or more of preventing the customer from opening a new customer account, preventing the customer from registering an e-mail address with an opened customer account, preventing the customer from registering a phone number with the opened customer account, preventing the customer from using an e-mail address or a phone number to register for a new transfer service token, or performing an additional customer validation operation.
